(19) United States
(12) Patent Application Publication
(10) Pub. No.: US 2022/0198952 A1
(43) Pub. Date: Jun. 23, 2022

(54) ASSESSMENT AND TRAINING SYSTEM

(71) Applicant: Human Foundry, LLC, Redwood City, CA (US)

(72) Inventors: Carri Allen JONES, Redwood City, CA (US); Patrick HOLLY, Austin, TX (US)

(73) Assignee: Human Foundry, LLC, Redwood City, CA (US)

(21) Appl. No.: 17/442,205

(22) PCT Filed: Mar. 25, 2020
(86) PCT No.: PCT/US20/24769

§ 371 Date: Sep. 23, 2021

Related U.S. Application Data
(60) Provisional application No. 62/824,686, filed on Mar. 27, 2019.

(51) Int. Cl. G09B 7/077; G06V 40/16; G06F 3/01

(52) U.S. Cl. CPC G09B 7/077; G06F 3/015; G06V 40/174

(57) ABSTRACT

An education and/or training system comprises a user interface configured to (a) present a lesson to a user, and (b) detect a first user characteristic of the user; a user performance analysis engine coupled to the user interface and configured to obtain, from the user interface, an indication the first user characteristic; an adaptation engine coupled to and configured to receive inputs from the user performance analysis engine; and a lesson presentation engine coupled to the adaptation engine and to the user interface and configured to receive inputs from the adaptation engine, provide inputs to the user performance analysis engine, and provide information to the user interface to enable the user interface to present the lesson to the user.

### CROSS-REFERENCE TO RELATED APPLICATIONS

This application claims the benefit of and hereby incorporates by reference, for all purposes, the entirety of the contents of U.S. Provisional Application No. 62/824,686, filed Mar. 27, 2019 and entitled “ASSESSMENT AND TRAINING SYSTEM.”

### BACKGROUND

Education and training (generally referred to herein as education) today generally takes place in a classroom or over the Internet, either in person or in an asynchronous manner (e.g., via recordings). In both settings, the number of attendees (e.g., enrolled students, employees, or executives), generally referred to herein as students, typically vastly outnumbers the number of instructors, thus limiting an instructor's ability to assess each student's progress. Furthermore, programs are typically not personalized for each student's learning style. An additional problem is that the number of applicants for certain programs (e.g., MBA, university, etc.) exceeds the number of positions available to be filled. As a consequence, a limited number of students have access to the world's best academic instructors.

Moreover, because a single lesson plan is directed to multiple students, lessons in classrooms and in online education tend to be designed for an average or typical “generic” student expected to consume a lesson. If changes to the course speed and/or content are even possible, such as in a classroom setting, they are generally directed to the average student who is actually taking the course. Because lessons tend to be directed to average students, a lesson plan may be too difficult for some students, potentially leading to frustration and/or disengagement. In contrast, the lesson plan may be too easy for other students, potentially leading to boredom and/or disengagement. Furthermore, when the same lesson is presented to multiple students, the mode of presentation of content may resonate with some students, but not with others. For example, students who learn best by hearing the material (auditory learners) might do well in a classroom setting, whereas students who learn best by writing (kinesthetic learners) might not do as well.

Classroom settings suffer from additional drawbacks as well. For example, in a classroom setting, shy or introverted students may hesitate to participate, which can negatively impact the quality and quantity of their education. Classroom-based instruction also requires the physical presence of students. Business executives and employees have limited time and resources to attend executive education. Executive MBA programs have limited availability for participants and cannot accommodate everyone who would like to participate. Pandemics such as the recent coronavirus pandemic can also disrupt the availability of classroom education as governments issue “shelter-in-place” or similar orders that forbid students and instructors from being physically present in the same room.

Online education can solve some of the problems of classroom-based education, but it also suffers from its own drawbacks. Among the advantages is that students and instructors need not be collocated. Because online classes do not require students to gather in a single location, online classes can be more convenient and flexible than classroom-based courses. Moreover, students may be able to progress through a lesson plan at their own pace. On the other hand, online education lesson plans are also typically designed with an average student in mind. As a result, like classroom lesson plans, online lesson plans suffer from the drawback that the content is aimed at average students. Unlike classroom lesson plans, which can be modified on the fly as the instructor assesses student progress at a macro level, for example, by observing facial expressions and student engagement during in-person lectures, online lesson plans tend to be fixed at a selected level and in a particular form. If the material is presented in a way that is not effective for the student (e.g., the student learns best by interacting with others or by hearing the material and then repeating it back to the instructor for immediate confirmation), the student may progress more slowly and/or may learn less well than in a classroom setting. Additionally, even if the instructor could modify the lesson plan, presentation style, or other aspects of the course on the fly if the instructor were aware of students' struggles, a student's lack of progress and/or learning might not be detectable by the remotely-located instructor unless the student complains or otherwise notifies the instructor.

Furthermore, although introverted or shy students may feel more comfortable with the arms-length nature of online education, extroverted students may be less engaged because of the absence of other students, which may negatively affect their learning experience. In addition, online classes may not include the types of motivational elements that classroom-based education provides (e.g., the need to be prepared because of the prospect of being called on in class, examinations at pre-designated times, etc.), and, as a result, students may progress more slowly than they would in a classroom setting, or, in some cases, not complete a class at all. In fact, it is known that many people who begin online courses never complete them, even when they have paid for those courses. (See, e.g., https://www.influencive.com/why-no-one-finishes-online-courses.)

A significant issue with existing computer-based education and training programs is that they typically support one “correct” answer. Feedback is static and hard-coded, potentially with some video and graphics included to increase visual appeal and to illustrate concepts. Users navigate through the lesson along a single, pre-defined path. There is little or no business model support, and feedback is typically at the level of whether a particular answer was correct or incorrect. Thus, the student knows only that he or she was wrong, but not necessarily why or how not to be wrong in the future.

Many real-world activities do not lend themselves to right/wrong determinations, however. Gaining proficiency in many practical skills relies on ongoing nuanced feedback (e.g., suggestions of how to do better next time) that typical computer-based programs cannot provide, because these programs do not provide realistic simulations of situations in which training is required. In-classroom or traditional online education does not generally immerse the participant in a case study or lesson and thus does not allow behavioral, cognitive, physical, or haptic feedback to augment the lesson. Current grading and assessment standards are also outdated for immersive learning. In a candidate-driven market, talent recruitment and retention are challenging issues for businesses.

Some valuable skills needed to navigate and progress in the workplace are mastered only by practicing an activity. As just one example, few new attorneys are capable of taking an effective deposition. They become skilled at taking depositions only by taking depositions, whether in training courses (which opportunities can be infrequent and/or expensive) or by taking real depositions in the course of practicing law. One disadvantage of practicing some skills in real-world situations is, of course, that failure can have a high cost.

One-on-one instruction is known to improve learning outcomes relative to one-to-many instruction. Among other benefits, one-on-one instruction allows instructors to customize lessons, both in content and in presentation, to attempt to optimize the instruction based on a specific student's abilities and learning style. One-on-one instruction also enables students to receive more time and attention from instructors. Many students have less anxiety about making mistakes when the instructor is the only person in front of whom mistakes will be made. Other students prepare more diligently and thoroughly, knowing that they will be in a one-on-one setting with their instructor, and any failure to prepare will be more easily detected than in a classroom setting. One-on-one instruction is also flexible and convenient for students. It does not rely exclusively on right/wrong answers to questions to assess a student's progress. Furthermore, students can be paired with instructors whose teaching styles match the students' preferences, which may save time and effort to learn new concepts.

A significant disadvantage of one-on-one instruction, however, is cost. Most students, or their sponsors (e.g., a parent, company, etc.), cannot afford to pay an instructor to educate a single student. Moreover, there is a scarcity of instructors available to teach students one-on-one, and most instructors cannot teach all of the subjects that might be of interest to a student (e.g., a biology instructor is unlikely also to be able to teach art history, and vice versa).

There is, therefore, an ongoing need for education solutions that provide the benefits of one-on-one education, including flexibility, personalization, and effectiveness, without requiring a one-to-one instructor-to-student ratio. There is also a need for education systems that support training for skills that do not lend themselves to evaluation based on answers to questions in the traditional right/wrong format.

There are related problems in the human resources context. For example, when there is a large pool of applicants for an open position, the process of assessing whether each candidate has an appropriate skill set and an appropriate personality for that position can be time consuming and expensive, often requiring multiple face-to-face interviews. Moreover, the process is inherently subjective and can be affected by biases, whether known or latent, of the person or people conducting the assessment process. From the job applicant's perspective, the interview process can be daunting, particularly for introverts and those who tend to be shy, which might discourage some applicants from applying for suitable jobs. There is, therefore, an ongoing need to address these and other problems.

### SUMMARY

This summary represents non-limiting embodiments of the disclosure.

Disclosed herein are embodiments of an assessment and training system that includes simulation of a variety of activities. The system improves personalized learning experiences by identifying and learning the user's time, motion, expressed preferences, typical behaviors, etc. to adapt to users' ways of working and learning, rather than forcing users to adapt to the system. The efficiency of new learning and retention e.g., the ability to memorize, retain, and identify the content and skills taught through a lesson is improved through the application of successive simulation exercise tasks, both cognitive and physical. The enjoyment of learning can be improved with multi-player lesson engagement with students and/or colleagues from other schools, institutions, companies, countries, etc. Conversely, learning can be passive through watching others perform in a lesson or case study simulation.

In some embodiments, a system comprises a user interface, a user performance analysis engine coupled to the user interface and configured to obtain, from the user interface, an indication the first user characteristic, an adaptation engine coupled to and configured to receive inputs from the user performance analysis engine, and a lesson presentation engine coupled to the adaptation engine and to the user interface. In some embodiments, the user interface is configured to (a) present a lesson to a user, and (b) detect a first user characteristic of the user. In some embodiments, the lesson presentation engine is configured to receive inputs from the adaptation engine, provide inputs to the user performance analysis engine, and provide information to the user interface to enable the user interface to present the lesson to the user.

In some embodiments, the user interface comprises a camera or a microphone.

In some embodiments, the first characteristic is a facial expression, and wherein the user performance analysis engine is configured to determine a level of at least one of happiness, surprise, sadness, disgust, anger, frustration, or fear of the user based on the facial expression. In some such embodiments, the user performance analysis engine is further configured to determine a change to the lesson based at least in part on the level of at least one of happiness, surprise, sadness, disgust, anger, frustration, or fear of the user. In some embodiments, the adaptation engine is further configured to implement a change to the lesson based at least in part on the level of at least one of happiness, surprise, sadness, disgust, anger, frustration, or fear.

In some embodiments, the inputs to the user performance analysis engine comprise information about the lesson.

In some embodiments, the adaptation engine is configured to implement a change to the lesson based on the inputs from the user performance analysis engine.

In some embodiments, the system further comprises at least one biometric device configured to obtain a second user characteristic of the user, and a biometrics analysis engine coupled to and configured to receive an indication of the second user characteristic from the user, wherein the biometrics analysis engine is coupled to and configured to provide inputs characterizing the second user characteristic to the adaptation engine.

In some embodiments in which the system further comprises at least one biometric device configured to obtain a second user characteristic of the user, the second user characteristic is a pulse, a heart rate, a blood oxygen level, or an electrical signal representing a physiological characteristic of the user. In some embodiments in which the system further comprises at least one biometric device configured to obtain a second user characteristic of the user, the at least one biometric device comprises a heart-rate monitor, a pulse oximeter, an EEG, an EKG, a wearable device, or a mobile device. In some embodiments in which the system further comprises at least one biometric device configured to obtain a second user characteristic of the user, the biometrics analysis engine is configured to determine a level of stress of the user based on the inputs characterizing the second user characteristic. In some embodiments in which the system further comprises at least one biometric device configured to obtain a second user characteristic of the user, the adaptation engine is configured to implement a change to the lesson based on the inputs characterizing the second user characteristic. In some embodiments in which the system further comprises at least one biometric device configured to obtain a second user characteristic of the user, the adaptation engine is configured to resolve a conflict between the inputs from the biometrics analysis engine and the user performance analysis engine by prioritizing the inputs characterizing the second user characteristic. In some embodiments in which the system further comprises at least one biometric device configured to obtain a second user characteristic of the user, at least one of the user performance analysis engine, the adaptation engine, the lesson presentation engine, or the biometrics analysis engine is implemented using a processor. In some embodiments, the biometrics analysis engine is configured to receive an indication of a third user characteristic, and create a personal identification signature for the user based on the indication of the second user characteristic and the indication of the third user characteristic.

### BRIEF DESCRIPTION OF THE DRAWINGS

So that the manner in which the above-recited features of the present disclosure can be understood in detail, a more particular description of the disclosure is in reference to embodiments, some of which are illustrated in the appended drawing. It is to be noted, however, that the appended drawing illustrates only a typical embodiment of this disclosure and is therefore not to be considered limiting of its scope, for the disclosure may admit to other equally-effective embodiments.

FIG. 1 is a conceptual block diagram illustrating various components of an assessment and training system in accordance with some embodiments.

### DETAILED DISCLOSURE

Disclosed herein are embodiments of an assessment and training system that includes simulation of a variety of activities. The system improves personalized learning experiences by identifying the user's time, motion, expressed preferences, typical behaviors, etc. to adapt to users' ways of working and learning, rather than forcing users to adapt to the system. The efficiency of new learning and retention e.g., the ability to memorize, retain, and identify the content and skills taught through a lesson is improved through the application of successive simulation exercise tasks, both cognitive and physical. The enjoyment of learning can be improved with multi-player lesson engagement with students and/or colleagues from other schools, institutions, companies, countries, etc. Conversely, learning can be passive through watching others perform in a lesson or case study simulation.

In accordance with some embodiments, talent recruitment and retention are improved through biometric-analyzed knowledge and skill screening, to identify learning and communication style. In the recruitment phase, the system allows a large applicant pool to be screened to distinguish between stronger and weaker applicants, thereby making the process of filling an open position less time-consuming and more efficient. Hiring managers can spend time interviewing only those applicants determined to be suitable for an open position. Using at least some of the embodiments presented herein, preparedness in cyber security can be improved through creating employee and executive physical and behavioral biometric signatures.

The disclosures herein can be used to match service providers with those who consume their services. For example, a system in accordance with some embodiments can select an instructor with particular personality traits for a student whose learning the system determines (e.g., based on information gathered by the system, as described in further detail below) would be enhanced by having an instructor with those personality traits. The applications of the system, methods, and concepts disclosed herein extend beyond students and instructors. As just some examples, the system can be used to select employees for employers (or vice versa), physicians for patients (or vice versa), attorneys for clients (or vice versa), personal trainers for clients (or vice versa), or ride-sharing drivers for customers (or vice versa). One advantage of the system is that it can eliminate biases, whether conscious or unconscious, that might otherwise play a role in service consumers' (or service providers') decision-making processes. Accordingly, the system may be able to make a better choice among a suite of options than a person might otherwise make when faced with that suite of options.

Thus, the disclosures herein in an education/training context are merely exemplary and are not intended to be limiting. Those having skill in the art will recognize that the disclosed systems and methods can be useful and applicable in other environments as well.

In some embodiments, the system includes a virtual instructor. The virtual instructor may be created using any of a variety of methods, such as, for example, three-dimensional (3D) modeling, video capture, and/or motion capture. This instructor can interact with an individual user, assessing and assisting in improvement of the user's performance and understanding of the subject material. Using biometrics and other methods, metrics such as, but not limited to, comfort level, subject knowledge, accuracy, voice recognition, text recognition, interpolation, and/or extrapolation, can be taken in order to determine the performance of the user at any given time. These metrics can then be analyzed through a variety of means, such as but not limited to, pre-determined responses, machine learning, artificial intelligence, and/or quantum analysis, and the analysis can be used to determine materials and locations in which the user needs improvement. The content of the subject matter can also be updated through manual or automatic means in order to improve the materials with relevant changes.

In some embodiments, material from two or more subject areas is combined by artificial intelligence in order to create individualized lessons that can teach a student more than one subject at the same time. For example, a student learning biology and math could be given a lesson in which the math questions include terminology from a biology lesson. For example, the student could be asked, “If I have two amoeba and then add three amoeba, how many amoeba do I have?” The combination of material from two subject areas can facilitate the student learning two different topics simultaneously.

In some embodiments, artificial intelligence is used to direct and/or monitor progress of a particular aspect of a person's habits or education. For example, after an employee is given a review by his or her employer, the employee can be monitored and/or directed to tasks that would help the employee improve in an area designated either by the reviewer, the artificial intelligence system, or another means, thereby ensuring adequate opportunity to improve in the target area(s).

In some embodiments, a unique personal identification signature is created through a combination of biometrics. For example, an artificial intelligence system can combine data or measurements from two or more biometric sources to ensure the user is human and specific. For example, a physiologic response (e.g., EEG or heart rate variability), cognitive response (e.g., a correct answer to a pre-set personal question or lesson), and/or psychological response (facial recognition identifying happiness) could be combined to create a unique personal identification signature.

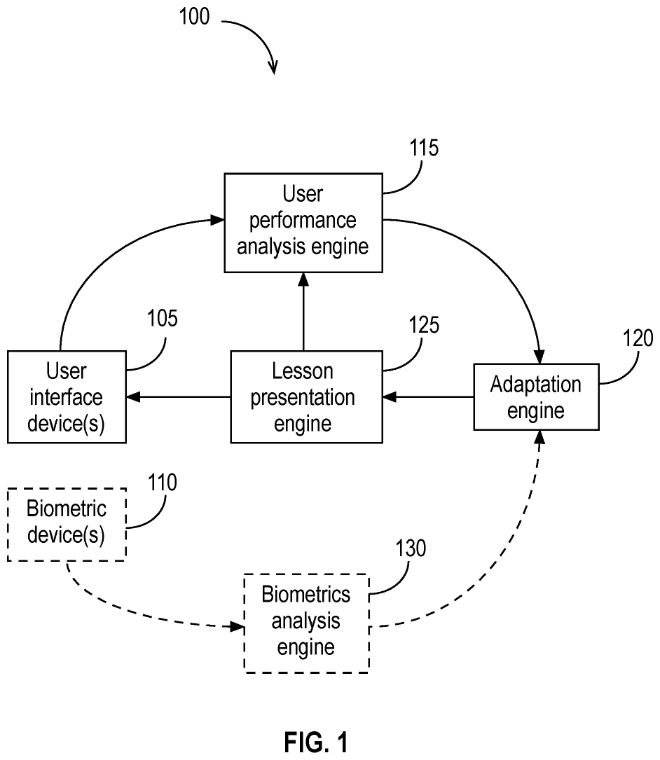

FIG. 1 is a conceptual block diagram illustrating various components of an assessment and training system in accordance with some embodiments. As shown in FIG. 1, in some embodiments, the system 100 includes one or more user interface devices 105, one or more optional biometric devices 110, a user performance analysis engine 115, an adaptation engine 120, a lesson presentation engine 125 (where a lesson may be for the purpose of teaching or assessment), and an optional biometrics analysis engine 130. (FIG. 1 shows optional components and optional communication paths between components using dashed lines.) In some embodiments, the user interacts with the system 100 actively through the one or more user interface devices 105 and passively through one or more optional biometric devices 110 that may be coupled to the user, as explained in more detail below. The user interface device(s) 105 are communicatively coupled to (i.e., in communication with, but not necessarily through a wired connection) the user performance analysis engine 115, which assesses the user's behavioral performance by analyzing the user's interaction with the system 100 through the user interface device(s) 105. If present, the biometric device(s) 110 are communicatively coupled to the biometrics analysis engine 130, which, if present, assesses the user's physiological performance during the lesson by analyzing data from the biometric device(s) 110. The user performance analysis engine 115 and, if present, the biometrics analysis engine 130 are communicatively coupled to the adaptation engine 120, which determines how and whether to change the lesson based on at least the user's behavioral responses, and if present, the user's physiological responses. The adaptation engine 120 is communicatively coupled to the lesson presentation engine 125, which implements the changes, if any, prescribed by the adaptation engine 120 and presents the lesson to the user through the user interface device(s) 105.

The arrows in the exemplary system of FIG. 1 show exemplary directions in which data or information may flow. It is to be understood that data or information may flow in other directions (e.g., from the user performance analysis engine 115 to the user interface device(s) 105, such as to give the user an indication of his or her performance on a lesson; from the user interface device(s) 105 to the lesson presentation engine 125, such as to allow the user to select a lesson; etc.). Moreover, it is to be understood that although FIG. 1 does not illustrate communication paths between certain of the components (e.g., between the user interface device(s) 105 and the biometric device(s) 110, etc.), FIG. 1 is merely exemplary. It is contemplated that there may be additional or alternative communication paths that are not illustrated in the exemplary block diagram of FIG. 1 (e.g., between biometric device(s) 110 and adaptation engine 120, between biometric device(s) 110 and user interface(s) 105, etc.). In general, any of the components illustrated in FIG. 1 can be communicatively coupled to any other components, and data or information may flow to and from each of the illustrated components.

The one or more user interface devices 105 may be any type of device through which a user can consume, interact with, and respond to content presented by the system. Examples of user interface devices 105 include a computer, a mobile device (e.g., a smartphone, a tablet, a laptop, etc.), a head-mounted display (e.g., a display device, worn on the head or as part of a helmet, that has a small display optic in front of one or both eyes), a keyboard (real or virtual), a display, a microphone, a speaker, a haptic device, etc.

The one or more user interface devices 105 may provide one or more user interfaces of any type, including, for example, an attentive user interface that manages the user's attention by managing the timing, content (e.g., level of detail), and style of notifications and/or interactions (e.g., via sound, visual, haptic, or some combination). Attentive user interfaces can, for example, decide when to interrupt the user, the kind of warnings/notifications to present, and the level of detail of the messages presented to the user. By generating only selected information, attentive user interfaces can be used to display information in a way that increases the effectiveness of the interaction.

As another example, the one or more user interface device(s) 105 may include a command line interface that allows the user to provide input by entering a predefined command string via a real or virtual keyboard and provides output via a screen (e.g., a computer screen, a mobile device display, etc.).

As another example, the one or more user interface devices 105 may include a conversational interface that enables the user to provide input to the system in plain text (e.g., in English or another language via text messages, chatbots, etc.) or voice commands, instead of graphic elements. A conversational interface can emulate human-to-human conversations.

As yet another example, the one or more user interface devices 105 may include a conversational interface agent, which personifies the system interface in the form of an animated person, robot, or other character and facilitates interactions in a conversational form.

As another example, the one or more user interface devices 105 may include a direct manipulation interface that allows the user to manipulate objects presented to him/her using actions similar to those the user would employ in the real world. Similarly, the one or more user interface devices 105 may include a gesture interface, which is a graphical user interface that accepts input in a form of hand gestures or mouse gestures accomplished using an instrument such as, for example a computer mouse, a stylus, or similar instrument.

As another example, the one or more user interface devices 105 may include a graphical user interface, which is a user interface that accepts input from devices such as a computer keyboard, mouse, touchscreen, etc., and provides graphical output on a display device, such as a computer monitor or a head-mounted display.

As another example, the one or more user interface devices 105 may include a hardware interface, which is a physical, spatial interface such as a knob, button, slider, switch, touchscreen, etc.

As another example, the one or more user interface devices 105 may include a holographic user interface that provides input to electronic or electro-mechanical devices by passing a finger through reproduced holographic images of what would otherwise be tactile controls of those devices, floating freely in the air, detected by a wave source and without tactile interaction.

As another example, the one or more user interface devices 105 may include an intelligent user interface, which is a human-machine interface that aims to improve the efficiency, effectiveness, and naturalness of human-machine interaction by representing, reasoning, and acting on models of the user, domain, task, discourse, and media (e.g., graphics, natural language, gesture).

As yet another example, the one or more user interface devices 105 may include a motion-tracking interface to monitor the user's body motions and translate them into commands.

As another example, the one or more user interface devices 105 may include a multi-screen interface, which uses multiple displays to provide a more flexible interaction.

As another example, the one or more user interface devices 105 may include a natural-language interface that enables the user to type in (or otherwise convey, as, for example, by speaking) a question or other input.

As another example, the one or more user interface devices 105 may include a non-command user interface that observes the user and infers the user's needs and intentions without requiring the user to formulate explicit commands.

As another example, the one or more user interface devices 105 may include a reflexive user interface that allows the user to control and redefine aspects of the system 100 via the user interface.

As another example, the one or more user interface devices 105 may include a tangible user interface that emphasizes touch and the physical environment.

As another example, the one or more user interface devices 105 may include a task-focused interface that makes the performance of tasks, rather than the management of underlying information, the focus of the user's interaction with the system 100.

As another example, the one or more user interface devices 105 may include a text-based user interface that presents text to the user.

As another example, the one or more user interface devices 105 may include a touchscreen, which is a display that accepts input by the user touching the display (e.g., using his/her finger, a stylus, etc.).

As another example, the one or more user interface devices 105 may include a touch user interface, which is a graphical user interface that uses a touchpad or touchscreen display as both an input device and an output device. A touch user interface may be used in conjunction with haptic devices that provide output via haptic feedback.

As yet another example, the one or more user interface devices 105 may include a voice user interface that accepts input (e.g., via verbal commands, a keyboard, etc.) and provides output by generating voice prompts.

As another example, the one or more user interface devices 105 may include a web-based user interface that accepts input and provides output by generating a web page that is transmitted over the Internet and viewed by the user through a web browser program.

As another example, the one or more user interface devices 105 may include a zero-input interface, which obtains inputs from one or more sensors (e.g., biometric devices 110) instead of querying the user with input dialogs.

As another example, the one or more user interface devices 105 may include a zooming user interface, which is a graphical user interface in which information objects are represented at different levels of scale and detail. The user can change the scale of the area viewed to show more or less detail.

The one or more user interface devices 105 are communicatively coupled to the user performance analysis engine 115. The user performance analysis engine 115 assesses the user's performance based at least in part on user inputs obtained from the user interface device(s) 105. In some embodiments, the user performance analysis engine 115 obtains information about the lesson being presented from the lesson presentation engine 125 and uses this information to assess the user's performance. The information about the lesson may include, for example, the identity of the lesson, answers to quizzes, desired vocal quality, a target speaking cadence, or any other suitable information indicative of the user's performance. The user performance analysis engine 115 may include memory containing some information about each lesson, and the information about the lesson obtained from the lesson presentation engine 125 may modify or augment that information based on changes made to the lesson by the adaptation engine 120.

The user performance analysis engine 115 may be configured to detect user characteristics. Such user characteristics can include, for example, one or more of a user's emotion, attention level, sentiment, etc. For example, in some embodiments, the user performance analysis engine 115 is capable of detecting a user's emotion, such as by analyzing the user's face, voice, pupils, eyebrows, mouth position, etc. In some embodiments, the user performance analysis engine 115 assigns a probability or confidence level to each of the user characteristics it is capable of detecting.

In some embodiments, the user performance analysis engine 115 is capable of detecting user characteristics via facial recognition technology. For example, the user performance analysis engine 115 may be able to detect the user's emotion by analyzing an image or set of images (e.g., video or multiple still images) of the user taken while the lesson is in progress. The user performance analysis engine 115 may be able to detect, for example, one or more of happiness, surprise, sadness, disgust, anger, frustration, or fear. In some embodiments, the user performance analysis engine 115 assigns a probability or confidence level to each of the emotions it is capable of detecting.

The user performance analysis engine 115 may also be able to determine the user's level eye contact and/or attention from an image or set of images (e.g., video or set of still images) of the user taken while the lesson is in progress. For example, the user performance analysis engine 115 may assign an eye contact level (e.g., on a scale of 1 to 10) or an attention level (e.g., on a scale, as a percentage, etc.) to the user. As another example, the user performance analysis engine 115 may be able to detect whether a user has rolled his or her eyes, is looking away from whether the user is supposed to be looking, or has fallen asleep.

In some embodiments, the user performance analysis engine 115 assesses the user's head pose (e.g., position) or the user's posture based on one or more images of the user taken during the lesson's progression. The user performance analysis engine 115 can use the head pose or posture information to, for example, assess whether the user is paying attention, whether the user is feeling defeated by the lesson, whether the user is engaged, etc. The user performance analysis engine 115 may assign a probability or confidence level to its determinations.

The user performance analysis engine 115 may also be able to determine whether the user is present or has walked away from the lesson. The user performance analysis engine 115 may be able to determine whether the user is distracted (e.g., eating, drinking, looking at his/her phone, etc.).

The user performance analysis engine 115 may also be capable of converting the user's speech to text for further analysis. The user performance analysis engine 115 may be able to analyze the user's speech to determine the user's sentiment (e.g., negative or positive) or emotion (e.g., joy, anger, disgust, fear, frustration, sadness, etc.). In some embodiments, the user performance analysis engine 115 is capable of assigning a probability or confidence level to each of the sentiments or emotions it is capable of detecting from the user's speech.

In some embodiments, the user performance analysis engine 115 applies a processing algorithm to the detected user characteristics to determine whether and how the lesson should be changed (e.g., in speed, presentation, style, etc.). For example, if the user performance analysis engine 115 determines with a confidence level of 9 out of 10 that the user's brow is furrowed, the user performance analysis engine 115 may determine that the pace of the lesson needs to be reduced. As another example, if the user performance analysis engine 115 determines with a confidence level of 8 out of 10 that the user has rolled his or her eyes and determines with a confidence level of 7 out of 10 that the user is looking at his or her phone, the user performance analysis engine 115 may determine that the presentation characteristics of the lesson need to be modified to improve user engagement and/or satisfaction. In some embodiments, the user performance analysis engine 115 monitors the user characteristics more-or-less continuously as the lesson progresses.

In some embodiments, the user performance analysis engine 115 recommends to the adaptation engine 120 whether changes to the lesson being presented are advisable. The recommendations can be substantially continuous, periodic (e.g., once every 30 seconds, once every 5 minutes, etc.), or asynchronous (e.g., made only when necessary). The recommendations can be directed to any part of a lesson (e.g., pace, presentation style, instructor characteristics (e.g., language, gender, etc.), etc.). As one example, the user performance analysis engine 115 may maintain a “user engagement” metric that may be based on observations of the user's eyes (e.g., whether the user is looking at the user interface, how often the user looks away, etc.). The user performance analysis engine 115 may have a threshold defined for when it recommends a change to the lesson. For example, the user performance analysis engine 115 may execute a rule that if the user engagement value falls below a threshold, the user performance analysis engine 115 will recommend a change to the style of the lesson presentation (e.g., from mainly lecture to a more interactive mode) to the adaptation engine 120. As another example, the user performance analysis engine 115 may recommend a change to the lesson to the adaptation engine 120 only if the user engagement value remains below the threshold for some period of time (e.g., 2 minutes).

In some embodiments, if the user performance analysis engine 115 determines that changes to the lesson are warranted, the user performance analysis engine 115 recommends what the changes should be. As just one example, the user performance analysis engine 115 may determine that the user has mastered a first aspect of the lesson but not a second aspect. As a result, the user performance analysis engine 115 may recommend that the entire lesson should be repeated, or a portion of the lesson focused on the second aspect should be repeated, or a new lesson should be delivered to present the second aspect in a different manner (e.g., by a different instructor, using different media (e.g., audio, visual, etc.), in a different format (e.g., via a game, via a different type of simulation, etc.), etc.). As another example, the user performance analysis engine 115 may determine that the user is frustrated or angry, and that a different type of presentation of the lesson may be warranted (e.g., presentation via a game, using different graphics, at a slower pace, etc.).

In some embodiments, the user performance analysis engine 115 simply reports the results of its assessment of the user's performance to the adaptation engine 120. For example, the user performance analysis engine 115 may simply report that the user has mastered a first aspect of the lesson but not a second aspect. As another example, the user performance analysis engine 115 may report that the user engagement is below a threshold, or has decreased by a specified amount (e.g., 20% less than 30 minutes ago), or is above a target user engagement, etc.

Based at least in part on the information from the user performance analysis engine 115 (e.g., one or more recommended changes to the lesson, objective data representing the user's performance and/or engagement, etc.), the adaptation engine 120 determines whether to make adjustments to the lesson. The adjustments may be, for example, to repeat the lesson or to change some characteristic of the lesson (e.g., the manner in which the lesson is delivered, the instructor presenting the lesson, the pace of the lesson, the content of the lesson, etc.). In some embodiments, the adaptation engine 120 may determine that it should skip part of a lesson, or change the order of presentation, or change the style of a lesson.

The adaptation engine 120 is communicatively coupled to the lesson presentation engine 125 and instructs the lesson presentation engine 125 to present the lesson, potentially with changes prompted by feedback about the user's performance from the user performance analysis engine 115. The lesson presentation engine 125 is communicatively coupled to the one or more user input devices 105 and interacts with the one or more user input devices 105 to cause the lesson to be presented and to obtain inputs from the user.

In some embodiments, the system 100 also includes one or more biometric devices 110. Biometrics is the measure of biological signals from a subject, including, but not limited to, electrical signal monitoring, muscle movement, eye tracking, facial expression, pulse oximetry, heart rate, perspiration, motion capture, cortisol level, glucose level, etc. The biometric device(s) 110 are capable of detecting and/or monitoring one or more biometrics. Examples of biometric devices 110 are heart-rate monitors, pulse oximeters, blood pressure cuffs, EEGs, EKGs, wearable devices (e.g., fitbit, Garmin, Apple Watch, etc.), mobile devices (e.g., mobile phones, tablets, etc. with heart-rate monitor apps installed), etc. Such biometric devices 110 may be capable of detecting and assessing physiological user characteristics associated with, for example, stress levels.

In embodiments including biometric device(s) 110, a biometrics analysis engine 130 obtains data collected by the one or more biometric devices 110 and analyzes the biometric data to make recommendations to the adaptation engine 120. For example, the biometric device(s) 110 may include a heart rate monitor that provides the user's heart rate to the biometrics analysis engine 130. The biometrics analysis engine 130 may determine that the user's heart rate has increased, indicating that the user may be feeling stress. In response the biometrics analysis engine 130 may recommend to the adaptation engine 120 that the pace of the lesson be reduced, or that recently presented content be presented again to increase the user's comfort with that material.

In embodiments including biometric device(s) 110, the adaptation engine 120 may include algorithms to handle apparent conflicts between the recommendations from the user performance analysis engine 115 and the biometrics analysis engine 130. For example, a user who is unsure of his/her mastery of material might correctly guess the answer to a question, or he/she might be able to conceal his/her uncertainty when verbally answering questions, but his/her biometrics might indicate the user's discomfort with his/her responses to the lesson. In such a case, the user performance analysis engine 115 might determine that the user's performance is excellent and recommend no changes, or even an increased pace, to the adaptation engine 120, but the biometrics analysis engine 130 might recommend a slower pace or a repeat of at least a portion of the lesson.

There are a number of algorithms the adaptation engine 120 may apply to resolve conflicts between the recommendations by the user performance analysis engine 115 and the biometrics analysis engine 130. For example, the adaptation engine 120 may weight the recommendations of the user performance analysis engine 115 and the biometrics analysis engine 130 differently (e.g., the user performance analysis engine 115 recommendations are weighted more heavily than the biometrics analysis engine 130 recommendations, or vice versa). As another example, the adaptation engine 120 may always accept and implement any remedial recommendation (e.g., a recommendation to slow the presentation, repeat a portion of the lesson, choose a different instructor, skip to a different part of a lesson, etc.), regardless of whether that recommendation is from the user performance analysis engine 115 or the biometrics analysis engine 130.

It is to be understood that FIG. 1 is a conceptual block diagram, and various of the illustrated blocks may be combined in an implementation. For example, some or all of the user performance analysis engine 115, the biometrics analysis engine 130, the adaptation engine 120, and the lesson presentation engine 125 can be combined into a single engine, which may be implemented, for example, in a programmable computer. Conversely, the various engines can be split into smaller units (e.g., subroutines, programs, etc.) in an implementation.

Some embodiments include, in addition, a gaming platform. In some embodiments, well-known, top-ranked, and/or famous instructors and/or participants are incorporated in the system to motivate students and help them learn. For example, the system 100 may allow the user to select an instructor or participants (e.g., a student learning marketing could be taught by Seth Godin, or add a favorite athlete to his or her class to take the course alongside the user).

In some embodiments, the first time a user attempts a lesson, the system 100 does not provide feedback while the lesson is ongoing in order to establish a baseline performance level. In some such embodiments, in subsequent attempts, the system 100 provides feedback to help the user adjust his/her performance.

The various engines described herein (i.e., the user performance analysis engine 115, the adaptation engine 120, the lesson presentation engine 125, and the biometrics analysis engine 130) may be implemented using one or more processors. For example, the system 100 may include at least one programmable central processing unit (CPU) which may be implemented by any known technology, such as a microprocessor, microcontroller, application-specific integrated circuit (ASIC), digital signal processor (DSP), or the like. The CPU may be integrated into an electrical circuit, such as a conventional circuit board, that supplies power to the CPU. The CPU may include internal memory and/or external memory may be coupled thereto. The memory may be coupled to the CPU by a suitable internal bus.

The memory may comprise random access memory (RAM), read-only memory (ROM), or other types of memory. The memory contains instructions and data that control the operation of the CPU. The memory may also include a basic input/output system (BIOS), which contains the basic routines that help transfer information between elements within the system 100. The system 100 is not limited by the specific hardware component(s) used to implement the CPU or memory components of the system 100.

Optionally, the memory may include external or removable memory devices such as floppy disk drives and optical storage devices (e.g., CD-ROM, R/W CD-ROM, DVD, and the like). The system 100 may also include one or more I/O interfaces, such as a serial interface (e.g., RS-232, RS-432, and the like), an IEEE-488 interface, a universal serial bus (USB) interface, a parallel interface, and the like, for the communication with removable memory devices such as flash memory drives, external floppy disk drives, and the like.

The memory may record some or all lessons and interactions with users (e.g., video, audio, user inputs, etc.). In some embodiments, the system 100 is able to play back a completed lesson. For example, the system 100 may allow users to play back lessons they previously completed (e.g., users may be able to log in and access a dashboard of completed lessons and their results). As another example, the system 100 may provide a library of completed lessons that users may access so that users can learn from other users' mistakes and/or successful lesson completions. The identities of users may be visible or obscured/removed from the recorded lessons, depending on user preference. The identity of a user whose lesson is being accessed by a different user may be obscured automatically or based on the preference of the user who completed the lesson.

The system 100 also includes the one or more user input devices 105, which may include at least any of the types of user interfaces discussed herein. For example, the one or more user input devices 105 may include graphic user interface such as a standard computer monitor, LCD, or other visual display. The one or more user input devices 105 may also include an audio system capable of detecting and/or playing an audible signal. The one or more user input devices 105 may also include a video or imaging system capable of capturing video and/or images. The one or more user input devices 105 may permit the user to enter responses or commands into the system 100 (e.g., a microphone, camera, keyboard, etc.). For example, the user may respond to a query in establishing a topic of interest computed by the system 100. The one or more user input devices 105 may also comprise a means for accessing the database of assessment material through a security protocol. The security protocol may prompt an end user to log-on to the platform by inputting a user name and password. The user one or more user input devices 105 may include a standard keyboard, mouse, track ball, buttons, touch sensitive screen, wireless user input device and the like. The one or more user input devices 105 may be coupled to the CPU by a suitable internal bus.

The system 100 may be in communication with at least one remote platform for accessing the system 100 through a network (e.g., the Internet or other wired or wireless network). The remote platform may be any suitable computer operative to access the system 100. Such computers include desktop computers, laptop computers, mobile phones, tablet computers, and the like. The remote platform may include a graphical user interface such as a standard computer monitor, LCD, or other visual display. The user interface may also include an audio system capable of playing an audible signal. The user interface may be a virtual reality (VR) headset or any type of head-mounted display. The user interface may be a VR display, an augmented reality (AR) display, or the like. The user interface may be a pair of smart glasses (e.g., an optical head-mounted display in the shape of a pair of eyeglasses, such as, e.g., Google glass). The user interface may permit the user to enter responses or commands into the platform for interaction with the system 100 through the network connection. For example, the user may respond to a query in establishing a topic of interest computed by the system 100.

The user interface may also comprise a means for accessing the database of assessment materials through a security protocol. The security protocol may prompt an end user to log-on to the platform by inputting a user name and password. The user interface may include a standard keyboard, mouse, track ball, buttons, touch sensitive screen, wireless user input device and the like. The user interface may be coupled to the CPU by an internal bus. The remote platform may also include memory coupled to the CPU by an internal bus. The memory may comprise random access memory (RAM) and read-only memory (ROM). The memory may also include a basic input/output system (BIOS), which contains the basic routines that help transfer information between elements within the remote platform. The system 100 is not limited by the specific hardware component(s) used to implement the CPU or memory components of the remote platform (if present).

The system 100 may also be in communication with an external database. The various components of the system 100 may be coupled together by internal buses. Each of the internal buses may be constructed using a data bus, control bus, power bus, I/O bus, and the like. The platform may include instructions executable by the CPU for operating the system 100 described herein. These instructions may include computer-readable software components or modules stored in the memory, or stored and executed on one or more other computers of the platform.

In the foregoing description and in the accompanying drawings, specific terminology has been set forth to provide a thorough understanding of the disclosed embodiments. In some instances, the terminology or drawings may imply specific details that are not required to practice the invention.

Unless otherwise specifically defined herein, all terms are to be given their broadest possible interpretation, including meanings implied from the specification and drawings and meanings understood by those skilled in the art and/or as defined in dictionaries, treatises, etc. As set forth explicitly herein, some terms may not comport with their ordinary or customary meanings.

As used in the specification and the appended claims, the singular forms “a,” “an” and “the” do not exclude plural referents unless otherwise specified. The word “or” is to be interpreted as inclusive unless otherwise specified. Thus, the phrase “A or B” is to be interpreted as meaning all of the following: “both A and B,” “A but not B,” and “B but not A.” Any use of “and/or” herein does not mean that the word “or” alone connotes exclusivity.

As used in the specification and the appended claims, phrases of the form “at least one of A, B, and C,” “at least one of A, B, or C,” “one or more of A, B, or C,” and “one or more of A, B, and C” are interchangeable, and each encompasses all of the following meanings: “A only,” “B only,” “C only,” “A and B but not C,” “A and C but not B,” “B and C but not A,” and “all of A, B, and C.”

To the extent that the terms “include(s),” “having,” “has,” “with,” and variants thereof are used in the detailed description or the claims, such terms are intended to be inclusive in a manner similar to the term “comprising,” i.e., meaning “including but not limited to.” The terms “exemplary” and “embodiment” are used to express examples, not preferences or requirements. The term “coupled” is used herein to express a direct connection/attachment as well as a connection/attachment through one or more intervening elements or structures.

The drawing is not necessarily to scale, and the dimensions, shapes, and sizes of the features may differ substantially from how they are depicted in the drawing.

Although specific embodiments have been disclosed, it will be evident that various modifications and changes may be made thereto without departing from the broader spirit and scope of the disclosure. For example, features or aspects of any of the embodiments may be applied, at least where practicable, in combination with any other of the embodiments or in place of counterpart features or aspects thereof. Accordingly, the specification and drawing are to be regarded in an illustrative rather than a restrictive sense.

We claim:

1. A system, comprising:
a user interface configured to (a) present a lesson to a user, and (b) detect a first user characteristic of the user;
at least one biometric device configured to obtain a second user characteristic of the user;
a user performance analysis engine coupled to the user interface and configured to obtain, from the user interface, an indication of the first user characteristic;
a biometrics analysis engine coupled to the at least one biometric device and configured to obtain, from the at least one biometric device, an indication of the second user characteristic;
an adaptation engine coupled to the user performance analysis engine and to the biometrics analysis engine, wherein the adaptation engine is configured to:
receive first inputs from the user performance analysis engine, the first inputs characterizing the first user characteristic,
receive second inputs from the biometrics analysis engine, the second inputs characterizing the second user characteristic, and
resolve a conflict between the first inputs and the second inputs; and
a lesson presentation engine coupled to the adaptation engine and to the user interface and configured to:
receive third inputs from the adaptation engine,
provide fourth inputs to the user performance analysis engine, and
provide information to the user interface to enable the user interface to present the lesson to the user.

2. The system recited in claim 1, wherein the user interface comprises at least one of a camera or a microphone.

3. The system recited in claim 1, wherein the first characteristic is a facial expression, and wherein the user performance analysis engine is configured to determine a level of at least one of happiness, surprise, sadness, disgust, anger, frustration, or fear of the user based on the facial expression.

4. The system recited in claim 3, wherein the user performance analysis engine is further configured to determine a change to the lesson based at least in part on the level of at least one of happiness, surprise, sadness, disgust, anger, frustration, or fear of the user.

5. The system recited in claim 3, wherein the adaptation engine is further configured to implement a change to the lesson based at least in part on the level of at least one of happiness, surprise, sadness, disgust, anger, frustration, or fear.

6. The system recited in claim 1, wherein the fourth inputs comprise information about the lesson.

7. The system recited in claim 1, wherein the adaptation engine is further configured to implement a change to the lesson based on the first inputs.

8. (canceled)

9. The system recited in claim 1, wherein the second user characteristic is a pulse, a heart rate, a blood oxygen level, or an electrical signal representing a physiological characteristic of the user.

10. The system recited in claim 1, wherein the at least one biometric device comprises a heart-rate monitor, a pulse oximeter, an EEG, an EKG, a wearable device, or a mobile device.

11. The system recited in claim 1, wherein the biometrics analysis engine is configured to determine a level of stress of the user based on the inputs characterizing the second user characteristic.

12. The system recited in claim 1, wherein the adaptation engine is configured to implement a change to the lesson based on the second inputs.

13. The system recited in claim 1, wherein the adaptation engine is configured to resolve the conflict between the first inputs and the second inputs by prioritizing the second inputs over the first inputs.

14. The system recited in claim 1, wherein at least one of the user performance analysis engine, the adaptation engine, the lesson presentation engine, or the biometrics analysis engine is implemented using a processor.

15. The system recited in claim 1, wherein the biometrics analysis engine is further configured to:
receive an indication of a third user characteristic, and
create a personal identification signature for the user based on the indication of the second user characteristic and the indication of the third user characteristic.

16. The system recited in claim 15, wherein the second user characteristic is a physiologic response and the third user characteristic is a psychological response.

17. The system recited in claim 16, wherein the physiologic response is determined from an EEG or a heart rate variability, and the psychological response is determined based on a facial expression.

18. The system recited in claim 1, wherein the adaptation engine is configured to resolve the conflict between the first inputs and the second inputs by applying a first weighting to the first inputs and applying a second weighting to the second inputs.

19. The system recited in claim 1, wherein the adaptation engine is configured to resolve the conflict between the first inputs and the second inputs by weighting the first inputs more heavily than the second inputs, or by weighting the second inputs more heavily than the first inputs.

20. The system recited in claim 1, wherein the adaptation engine is configured to resolve the conflict between the first inputs and the second inputs by accepting whichever of the first inputs or second inputs conveys a remedial recommendation.

21. The system recited in claim 1, wherein:
the first inputs convey a first remedial recommendation and the second inputs do not convey any remedial recommendation, and the adaptation engine is configured to resolve the conflict between the first inputs and the second inputs by accepting the first remedial recommendation; or
the second inputs convey a second remedial recommendation and the first inputs do not convey any remedial recommendation, and the adaptation engine is configured to resolve the conflict between the first inputs and the second inputs by accepting the second remedial recommendation.
